(19) United States
(12) Patent Application Publication
(10) Pub. No.: US 2008/0162561 A1
(43) Pub. Date: Jul. 3, 2008

(54) METHOD AND APPARATUS FOR SEMANTIC SUPER-RESOLUTION OF AUDIO-VISUAL DATA

(75) Inventors: Milind R. Naphade, Fishkill, NY (US); John R. Smith, New Hyde Park, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/619,342

(22) Filed: Jan. 3, 2007

(51) Int. Cl. G06F 17/30

(52) U.S. Cl. 707/104.1; 707/E17.009

(57) ABSTRACT

An embodiment of the present invention relates to the combining of multiple semantic analyses of audio-visual data in order to resolve a higher fidelity description of the semantic content and more specifically to a method for applying semantic concept detection over multiple related audio-video sources, scoring the sources on the basis of presence or absence of specific semantics and aggregating the scores using combination functions to achieve a semantic super-resolution.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to the combining of multiple semantic analyses of audio-visual data in order to resolve a higher fidelity description of the semantic content and more specifically to a method for applying semantic concept detection over multiple related audio-video sources, scoring the sources on the basis of presence or absence of specific semantics and aggregating the scores using a combination of functions to achieve a semantic super-resolution.

2. Description of Background

Before our invention unstructured information in the form of images, video, and audio required sophisticated feature analysis and modeling techniques to extract accurate semantic description of the contents. In many cases, the user may want to extract descriptions of real world scenes, events, activities, and objects that are captured in the audio-visual data when multiple views of these scenes, events, activities, and objects are available. For example, visitors to a tourist location will take pictures of the sites and make them available on photo sharing websites. Although any one picture only captures a specific view of the scenes, events, activities, and or objects, if the multiple views across pictures can be combined, they may provide a higher resolution description of the underlying scenes, events, activities, and or objects. In a similar manner, the same process can be considered for combining multiple sources of broadcast news in order to obtain a more accurate description of news events, or for combining multiple frames from the same video to extract a more detailed description of objects.

Extracting semantic descriptions of multimedia (audio-video) data is can be important in the context of enterprise content management systems, consumer photo management and search engines. Other examples, such as analysis of Internet data, web, chat rooms, blogs, streaming video, etc. it can be important to analyze multiple modalities, such as text, image, audio, speech, and XML. This type of data analysis involves significant processing in terms of feature extraction, clustering, classification, semantic concept detection, and so on. Multimedia, which is a form of unstructured information, is typically not self-descriptive in that the underlying audio-visual signals of image pixels require computer processing in order to be analyzed and interpreted to make sense out of the content. It is possible to extract semantic descriptions by computer using machine learning technologies applied to extracted audio-video features. For example, the computer can extract features such as color, texture, edges, shape, and motion. Then, by supplying annotated training examples of content for the semantic classes, for examples, by providing examples of photo of ‘cityscapes’ in order to learn the semantic concept ‘cityscape’, the computer can build a model or classifier based on these features. In practice a variety of classification algorithms can be applied to this problem, such as K-nearest neighbor, support vector machines, Gaussian mixture models, hidden Markov models, and decision trees features. Support vector machines (SVMs) describe a discriminating boundary between positive and negative concept classes in high-dimensional feature space.

For example, M. Naphade, et al., “Modeling semantic concepts to support query by keywords in video”, IEEE Proc. Int. Conf. Image Processing (ICIP), September 2002, teaches a system for modeling semantic concepts in video to allow searching based on automatically generated labels. This technique requires that video shots are analyzed using a process of visual feature extraction to analyze colors, textures, shapes, etc. followed by semantic concept detection to automatically label video contents, e.g., with labels such as ‘indoors’, ‘outdoors’, ‘face’, ‘people’, etc. . . . . Furthermore, new hybrid approaches, such as model vectors allow similarity searching based on semantic models. For example, J. R. Smith, et al., in “Multimedia semantic indexing using model vectors,” in IEEE Intl. Conf. on Multimedia and Expo (ICME), 2003, teaches a method for indexing multimedia documents using model vectors that describe the detection of concepts across a semantic lexicon. This approach requires that a full lexicon of concepts be analyzed in the video in order to provide a model vector index.

The known solutions for semantic content analysis are directed towards extracting semantic descriptions from individual items of multimedia data, for example, an image, a key-frame from a video, and a segment of audio. However, what is missing is the connection back to the underlying real world scenes captured by this multimedia data. By linking together related content, the combining of the extracted semantics can provide a better description of the underlying real world scenes. For example, consider a real world event of a parade. Many people attend the parade and take pictures. However, each picture captures only one small aspect of the parade indicating subsets of the people attending, activities, and objects. Any single photo may not be sufficient to answer the wide range of possible questions about the event, for example, “was the weather good throughout the parade?”, “did a particular marching band participate?”, “were US flags on display?”, “was the parade patriotic?”. Any single photo may not be sufficient to accurately answer the above questions. It is possible to applying the abovementioned semantic classification techniques to the individual photos, which may only attain a low confidence towards answering these questions.

Given the multimedia analysis approaches that are directed towards semantic concept extraction from individual multimedia data items, there is a need, which in part gives rise to the present invention, to develop a system that combines the semantic analyses to attain a higher fidelity representation of the underlying scene, events, activities, and or objects.

### SUMMARY OF THE INVENTION

The shortcomings of the prior art are overcome and additional advantages are provided through the provision of a method of determining the super resolution representation of semantic concepts related to multimedia data, the method comprising: organizing a plurality of multimedia data extracted from a plurality of signal sources, the plurality of signal sources are a plurality of views of an event; analyzing the plurality of multimedia data to determine a plurality of semantic concepts related to the plurality of multimedia data; determining a plurality of scored results, the plurality of scored results are determined in part by a plurality of models and or a plurality of detection algorithms; and aggregating the plurality of scored results using combination functions to produce a super resolution representation of semantic concepts related to the plurality of multimedia data.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution, which combines multiple semantic analyses of audio-visual data in order to resolve a higher fidelity description of the semantic content achieving a semantic super-resolution of the audio-visual data.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a multimedia semantic concept analysis system;

FIG. 2 illustrates one example of a method of selecting operating points from utility functions to perform an optimal utilization of resources given constraints;

FIG. 3 illustrates one example of the cascading of classification systems and optimization over the cascade; and

FIG. 4 illustrates one example of an application of the semantic super resolution processing across multiple frames in a video sequence.

The detailed description explains the preferred embodiments of the invention, together with advantages and features, by way of example with reference to the drawings.

### DETAILED DESCRIPTION OF THE INVENTION

Turning now to the drawings in greater detail in an exemplary embodiment of the present invention, the present invention provides a method and apparatus that improves the confidence by which semantic descriptions are associated with multimedia data as well as improves the quality by which questions about the real world or about the multimedia data can be answered or by which multimedia data items can be searched, retrieved, ranked, or filtered.

In an embodiment of the present invention, the present invention operates by combining multiple relevant multimedia data items and applies semantic analysis across the combination of items to produce a higher resolution description. The collecting or linking together of multiple multimedia data items allows capturing of different views of the same scenes, events, activities, and or objects. Semantic analysis allows the detecting and scoring of the confidence of the presence or absence of semantic concepts for each of the views. By aggregating the scored results using combination functions a semantic super resolution representation can be achieved. Once this semantic super resolution description is extracted, queries against the semantic super resolution descriptions can be processed. Scoring or ranking matching multimedia data on the basis of the semantic super resolution can retrieve descriptions according to the queries.

An advantage of the present invention is that it can provide a higher fidelity description of underlying real world scenes, events, activities, and or objects by combining the semantic analysis of multiple views of the same scenes, events, activities and objects. In this regard, resultant from the use of the semantic super resolution descriptions can be used to improve quality of searching or answering of questions from a large multimedia repository.

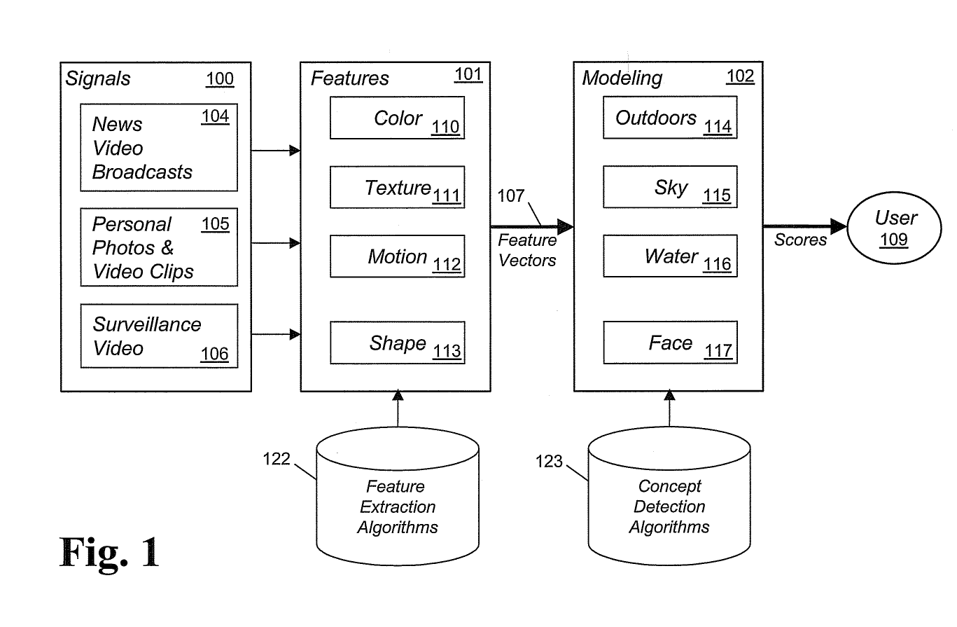

Referring to FIG. 1 there is illustrated one example of a multimedia semantic concept analysis system. In an exemplary embodiment FIG. 1 illustrates one example of a video semantic classification system. The system performs semantic concept detection on multimedia information sources, such as new video broadcasts 104, personal photos and video clips 105, and surveillance video 106. The processing for the large-scale classification system proceeds through multiple stages in which the multiple information sources or signals 100 are acquired and processed to extract features 101. The feature extraction process typically involves the extraction of descriptors of color 110, texture 111, motion 112, shape 113 and other feature descriptors. These descriptors also referred to as feature vectors 107 are then passed to one or more classification stages also referred to as modeling 102. For example, a first stage may involve atomic models that detect semantic concepts or classify the extracted feature vectors 107 into classes such as ‘outdoors’ 114, ‘sky’ 115, ‘water’ 116, ‘face’ 117 and other extracted features. The combined output of these classifiers based on atomic models may be represented as model vectors and passed to a subsequent classification stage that detects semantic concepts using composite models for concepts such as ‘beach’, ‘cityscape’, ‘farm’, and or ‘people’ to name a few. An output that is useable by a user 109 is the resultant.

In each of the aforementioned stages of processing feature extraction from signals 101, atomic modeling and composite modeling (modeling 102) it is possible to select from a variety of algorithms for processing. For example, the feature extraction process from signals 101 can select from different feature extraction algorithms 122 that use different processing in producing the feature vectors 107. For example, color features 110 are often represented using color histograms that can be extracted at different levels of detail. This allows exercising of the trade-off of extraction speed and accuracy of the histogram in capturing the color distribution. One fast way to extract a color histogram is to coarsely sample the color pixels in the input images. A more detailed way to extract the color histogram is to count all pixels in the images. Furthermore, it is possible to also consider different feature representations for color. In an exemplary embodiment a variety of color descriptors can be used for image analysis, such as color histograms, color correlograms, and color moments to name a few. The extraction algorithms 122 for these descriptors have different characteristics in terms of processing requirements and effectiveness in capturing color features. In general, this variability in the feature extraction stage can result from a variety of factors including the dimensionality of the feature vector representation, the signal processing requirements and whether the feature extraction involves one or more modalities of input data, e.g., image, video, audio, or text.

In a similar manner, the modeling stages 102 can involve a variety of concept detection algorithms 123. For example and not limitation, given the input feature vectors 107, it may be possible to use different classification algorithms for detecting whether video content should be assigned label ‘outdoors’. Concept detection algorithms 123 can be based on Naïve Bayes, K-nearest nearest, support vector machines, Gaussian mixture models, hidden Markov models, decision trees, neural nets and or other concept detection algorithms. They can also optionally use context or knowledge. This classifier variability provides a rich range of operating points from which to trade-off dimensions such as response time and classification accuracy.

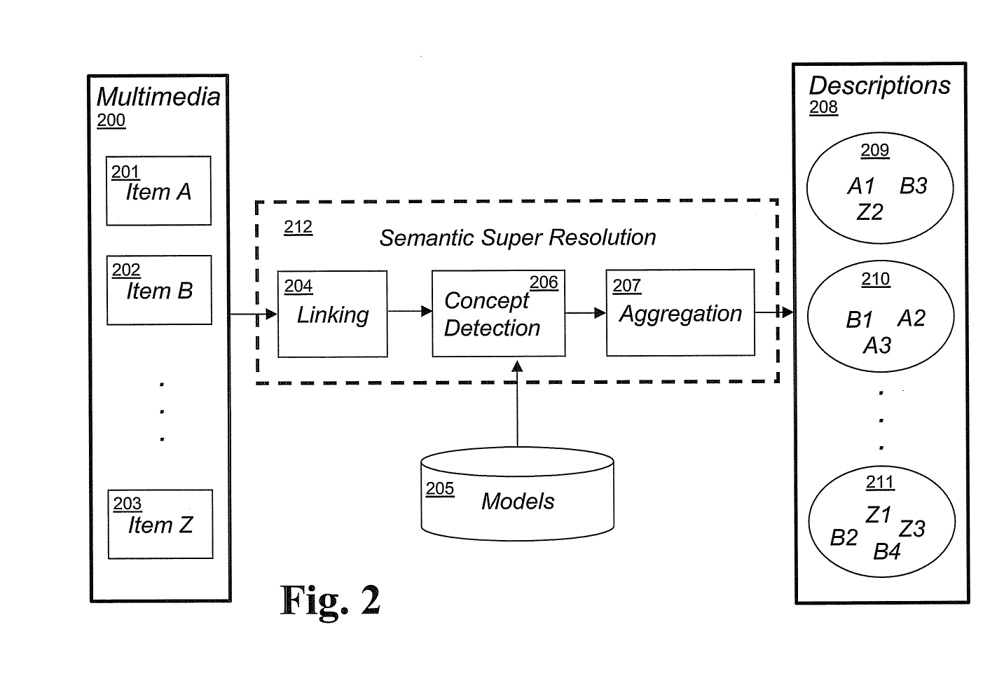

Referring to FIG. 2 there is illustrated one example of a method of selecting operating points from utility functions to perform an optimal utilization of resources given constraints. In an exemplary embodiment, FIG. 2 illustrates a method for extracting the semantic super resolution description from input multimedia 200. Multiple multimedia items 201-203 are provided; these items are then analyzed in the semantic super resolution processing 212 to produce a set of descriptions 208. The semantic super resolution process 212 first collects or links together in block 204 multiple relevant multimedia data items that capture different views of the same scenes, events, activities and or objects. The linking in block 204 can be based on clustering of the multimedia data based on extracted features or metadata (time, place, creator, camera, etc). For example, in an exemplary embodiment photos taken at the same location within a certain time period can be grouped together. It may be possible to glean from this information, for example, from the camera metadata such as EXIF tags, which can provide photo date and time, and or from GPS sensor data that can record location information. Furthermore, linking or grouping can be done, for example and not limitation, on the basis of information about produced content, such as the definition of programs, stories, and or episodes of produced audio-video multimedia content. For example, it can group together all video clips of the sports highlights from a broadcast news report. The linking can also be accomplished using model vectors that record some signature of the semantic contents or by using semantic anchor spotting of lower-level extracted semantics. Processing then moves to block 206.

The next block 206 applies concept detection for detecting the presence or absence of semantics with respect to each linked or grouped multimedia data item. The concept detection process can use a set of models 205 that can act as a classifier for detecting each of the semantic concepts. The concept detection block 206 can also score or rank the items. The detection of semantic concepts can be based on statistical modeling of low-level extracted audio-visual features or apply other types of rule-based or decision-tree classification and or apply other machine learning techniques. The optional scoring can provide a confidence score of the presence or absence of particular semantics, a probability of the semantics being associated with the data item, or a probability score, t-score and or other types and or kinds of measure of the level of detection of a particular semantics; for example a score of 9 out of 10 of a picture depicting ‘outdoors’. Processing then moves to block 207.

The next block involves aggregating 207 the results of the concept detection to produce the semantic super resolution description 208. The aggregation 207 can be produced using a combination of functions that compute the average, minimum, maximum, product, median, mode, and or weighted combination of the scores or rankings from the concept detection processing 206. For example, if a majority of the linked images within a group indicate a high score on detection of ‘outdoors’, then the aggregation block 207 can determine that the description ‘outdoors’ can be associated with the group. One of the purposes of the aggregation is to produce a more accurate scoring or detection of the semantics by pooling together the multiple independent semantic detection decisions about the linked multiple data items.

The output of the semantic super resolution processing is a set of semantic descriptions 208 across the linked items. For example, each semantic super resolution description 209-211 indicates a particular semantics, e.g. ‘outdoors’, and the linked multimedia data items that support that description.

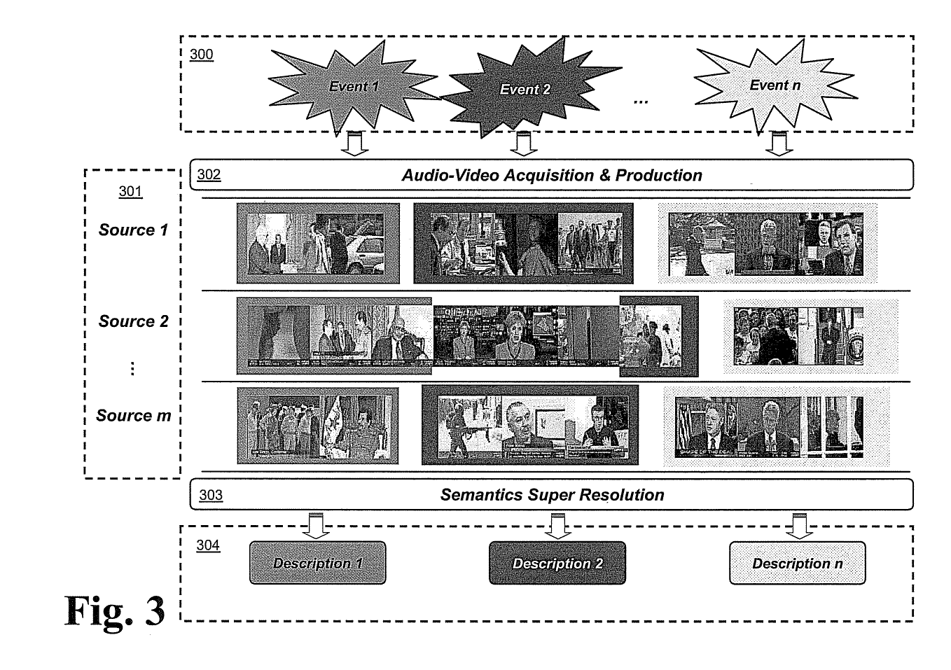

Referring to FIG. 3 there is illustrated one example of the cascading of the classification systems and optimization over the cascade. In an exemplary embodiment, FIG. 3 illustrates the application of the semantic super resolution processing 303 to analysis of events 300 captured and presented in broadcast news video. In this case, multiple content items relating to multiple events 300 taking place in the real world are captured and put through news production analysis. Multiple providers or news sources 301 can also perform the analysis. The semantic super resolution processing 303 is applied across the sources to gain insight into and or produce a description 304 of each of the events.

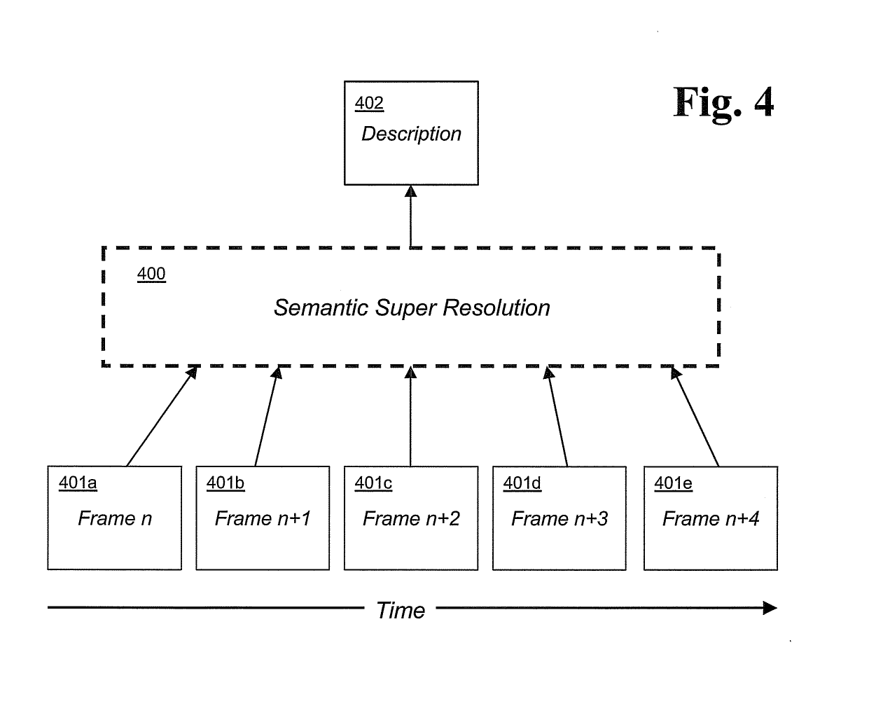

Referring to FIG. 4 there is illustrated one example of an application of the semantic super resolution processing 400 across multiple frames in a video sequence. Here, the multiple frames 401a-401e within a video shot are linked on the basis of temporal proximity. As a result, each of the frames provides a slightly different view of the scene, where the variation may result from camera motion and/or scene and object motion. The semantic super resolution processing 400 attains a higher fidelity description of the scenes, events, actions, and or objects captured in the video. The extracted description 402 can also be used as the basis for supporting searching or answering of questions about the scenes, events, action, and or objects analyzed in the semantic super resolution process. For example, a user can query the description ‘is the scene outdoors’, wherein the results produced from the semantic super resolution description are extracted from the multiple frames of video that captured the scene.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of determining the super resolution representation of semantic concepts related to multimedia data, said method comprising:
organizing a plurality of multimedia data extracted from a plurality of signal sources, said plurality of signal sources are a plurality of views of an event;
analyzing said plurality of multimedia data to determine a plurality of semantic concepts related to said plurality of multimedia data;
determining a plurality of scored results, said plurality of scored results are determined in part by a plurality of models and or a plurality of detection algorithms; and
aggregating said plurality of scored results using combination functions to produce a super resolution representation of semantic concepts related to said plurality of multimedia data.

2. The method in accordance with claim 1, wherein said event is at least one of the following: a plurality of scenes, an activity, or an object.

3. The method in accordance with claim 1, wherein organizing includes collecting and or linking said plurality of multimedia data.

4. The method in accordance with claim 1, further comprising:
organizing said plurality of multimedia data by clustering of said plurality of multimedia data based as a plurality of extracted metadata.

5. The method in accordance with claim 4, wherein said plurality of extracted metadata is at least one of the following: time, place, creator, and or camera.

6. The method in accordance with claim 4, further comprising:
linking said plurality of multimedia data based on grouping of programs, stories, and or episodes of produced audio-video multimedia content of said event.

7. The method in accordance with claim 6, further comprising:
linking said plurality of multimedia data using model vector indexing and or semantic anchor spotting of lower-level extracted semantics as the basis for clustering and linking said plurality of multimedia data.

8. The method in accordance with claim 7, wherein said plurality of multimedia data includes at least one of the following: images, video, audio, text, unstructured data, and or semi-structured data.

9. The method in accordance with claim 8, wherein said plurality of views is a video sequence corresponding to different time points of said event.

10. The method in accordance with claim 8, wherein said plurality of views is photos of said event corresponding to different time points of said event.

11. The method in accordance with claim 8, wherein said plurality of signals includes at least one broadcast signal and at least one web cast signal.

12. The method in accordance with claim 8, wherein said plurality of views correspond to a collection of multimedia data clustered or linked by computer or organized by a user.

13. The method in accordance with claim 8, wherein said plurality of semantic concepts is determined based on statistical modeling of low-level extracted audio-visual features or rule-based classification.

14. The method in accordance with claim 8, wherein said plurality of scored results includes at least one of the following: a confidence score of the presence or absence of a particular semantics, a probability score, or a t-score.

15. The method in accordance with claim 8, wherein aggregating includes using combination functions to determine at least one of the following: an average, a minimum, a maximum, a product, or a weighted combination of scores.

16. The method in accordance with claim 8, further comprising:
forming a question to be answered;
extracting a plurality of semantic super resolution descriptions from said plurality of multimedia data; and
answering said question by using said plurality of semantic super resolution descriptions to query and retrieve data from a multimedia repository.
